(19) United States
(12) Patent Application Publication
(10) Pub. No.: US 2013/0099066 A1
(43) Pub. Date: Apr. 25, 2013

(54) Backplane, Back Light Module and of Backplane Stiffener Locking Method

(71) Applicants: Shih hsiang Chen, Shenzhen (CN); Gang Yu, Shenzhen (CN)

(72) Inventors: Shih hsiang Chen, Shenzhen (CN); Gang Yu, Shenzhen (CN)

(21) Appl. No.: 13/375,401

(22) PCT Filed: Oct. 27, 2011
(86) PCT No.: PCT/CN11/81371

§ 371 Date: Nov. 30, 2011

(30) Foreign Application Priority Data
Oct. 20, 2011 (CN) 201110320358.9

(51) Int. Cl. G12B 9/10; B29C 65/56

(52) U.S. Cl. 248/27.1; 264/249

(57) ABSTRACT

The present invention discloses a backplane, a back light module, and a method of locking a backplane stiffener. The backplane includes a backplane surface and a stiffener fixed on the backplane surface, and the stiffener is locked by the fastener which is integrated with said backplane surface and is formed on said backplane surface. In the present invention, because the stiffener is locked on the backplane by the fastener formed on the backplane surface, and the fastener is integrated with the backplane, the fastener is tightly fixed on the backplane and is difficult to loosen. Then, the stiffener locked by the fastener is tightly locked on the backplane, preventing the phenomenon that the stiffening function of the stiffener is weakened because of the clearance produced between the stiffener and the backplane; and the stiffening function of the stiffener to the backplane is guaranteed. Thus, the structure of the whole backplane tends to be more reliable, and the backplane tends to be thinner.

### TECHNICAL FIELD

The present invention relates to the field of liquid crystal displays (LCDs), and more particularly to a backplane, a back light module, and a method of locking a backplane stiffener.

### BACKGROUND

As one of critical components of an LCD panel, a back light module has the function for supplying sufficient brightness and uniformly distributed light source so that LCD devices can normally display the image.

Generally, a back light module includes a backplane, a light guide plate, a light source and the like. The backplane is usually made of a metal by molding, and the cost of the backplane made of metal is high. To fix various circuit boards, various riveted bolts are usually employed, so that the manufacturing cost is increased. Furthermore, various equipments are involved to complete the manufacturing process, and thus the equipment cost and the production procedures are increased. Due to convenient molding and low price, plastic materials are increasingly used for producing backplanes of back light modules. However, the strength of plastic materials is far lower than that of metal materials, thus, to achieve a desired strength, a backplane made of a plastic material must be greatly thickened.

### SUMMARY

One objective of the present invention is to provide a backplane with a reliable structure, a back light module, and a method of locking a backplane stiffener.

The objective of the present invention is achieved by the following technical schemes. A backplane comprises a backplane surface and a stiffener fixed on the backplane surface; the stiffener is locked by a fastener which is integrated with the backplane surface and is formed on the backplane surface.

Preferably, the fastener is of a back-off structure formed by hot molding. Hot molding is a convenient and easy molding mode applicable to various materials.

Preferably, the backplane is made of plastic material. The backplane made of plastic material has advantages of low price, good plasticity, and easy processing.

Preferably, the stiffener is made of metal material. The stiffener made of metal material has high strength and can provide higher strength support. Therefore, the backplane can be designed to be thinner to produce increasingly thinner LCD devices.

Preferably, the backplane surface is integrally formed with a reinforced structure which protrudes above the backplane surface. The backplane strength is increased by the reinforced structure formed on the backplane surface. Thus, the backplane is not necessary to be thickened.

Preferably, the reinforced structure is mutually-crossed strip-shaped structures formed on the backplane surface. The mutually-crossed strip-shaped structures are simple and easy to mold, with obvious reinforced effect.

Preferably, the arrangement of the reinforced structure excludes a region for fixing the stiffener. That the arrangement of the reinforced structure excludes a region for fixing the stiffener prevents the arranged stiffener from protruding above the backplane and thus prevents the backplane from being thickened again to affect the assembling and sliming processes of other components.

Preferably, the thickness of the stiffener is equal to the height of the reinforced structure. That the thickness of the stiffener arranged is equivalent to the height of the reinforced structure prevents the arranged stiffener from protruding above the backplane to affect the assembling and sliming processes of other components.

A back light module comprises the aforementioned backplane.

A method of locking a backplane stiffener comprises the following steps:

A: Forming a column structure on a backplane surface of a backplane when molding the backplane;

B: Correspondingly arranging a stiffener with a hole(s) on the column structure on the backplane; and

C: Punching and shaping the column structure to form a fastener(s) which is used for locking the stiffener and is integrated with the backplane.

In the present invention, because the stiffener is locked on the backplane by the fastener formed on the backplane surface, and the fastener is integrated with the backplane, the fastener is tightly fixed on the backplane and is difficult to loosen. Then, the stiffener locked by the fastener is tightly locked on the backplane, preventing the phenomenon that the stiffening function of the stiffener is weakened because of the clearance produced between the stiffener and the backplane; and the stiffening function of the stiffener to the backplane is guaranteed. Thus, the structure of the overall backplane tends to be more reliable, and the backplane tends to be thinner.

### BRIEF DESCRIPTION OF FIGURES

FIG. 1 is a simplified structural diagram of a plastic backplane;

FIG. 2 is a simplified structural diagram of a plastic backplane equipped with a stiffener;

FIG. 3 is a sectional view of a plastic backplane equipped with a stiffener;

FIG. 4 is a simplified structural diagram of a backplane and a stiffener on the backplane of one embodiment of the present invention;

FIG. 5 is a structural sectional view of a backplane and a stiffener on the backplane of one embodiment of the present invention; and

FIG. 6 is an assembly diagram of a stiffener on a plastic backplane of the present invention.

Wherein: 100. backplane; 110. reinforced structure; 120. fastener; 121. column structure; 130. heat source; 140. cold punch; 200. stiffener; 300.screw.

### DETAILED DESCRIPTION

The present invention will further be described in detail in accordance with the figures and the preferred examples.

A backplane is of a square plane structure, wherein, the backplane is generally made of metal material. Optionally, the backplane can be made of plastic material and can be made of both metal and plastic material by joining For a backplane made of plastic material or a thin backplane made of metal material, the backplane surface is generally provided with a reinforced structure. Additionally, a stiffener is arranged to increase the total strength of the backplane, so as to save the material cost of the backplane under the condition that the packaging backplane strength is achieved.

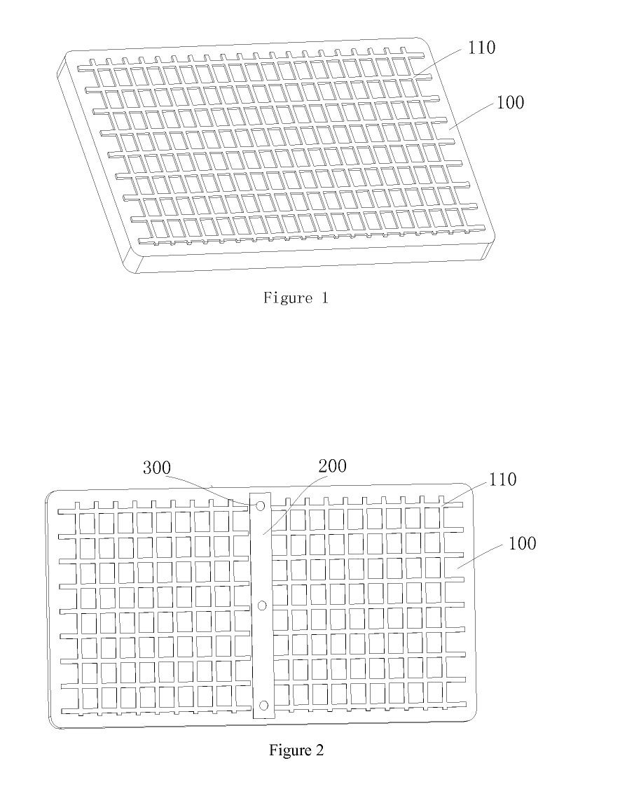

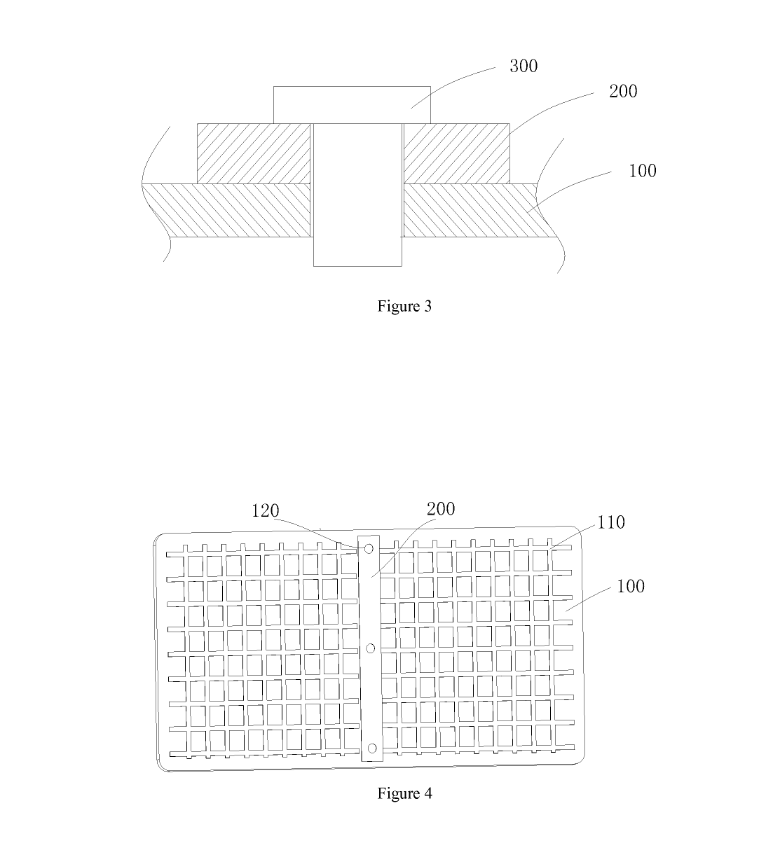

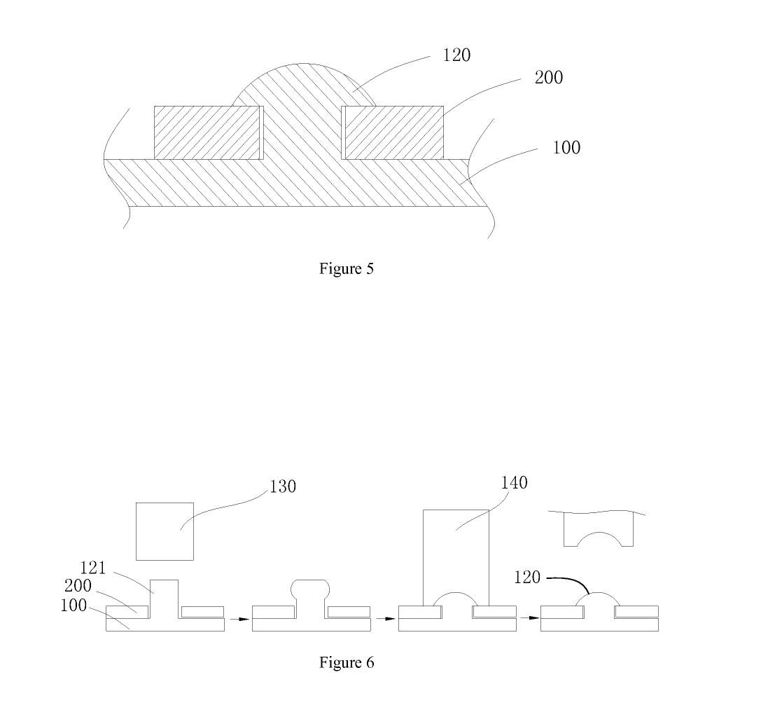

The embodiment of the present invention is shown in FIG. 1 to FIG. 5. In the embodiment, a backplane 100 is made of plastic material. Optionally, the backplane 100 can be made of other material such as metal or can be made of various materials by joining As shown in FIG. 1, the backplane 100 is of a square plane structure. The backplane surface is formed with a reinforced structure 110. The reinforced structure 110 is formed when the backplane is modeled. The structure of the reinforced structure 110 is not limited to the mutually-crossed and equidistant stripe-shaped structures as shown in the figure. The arrangement of the reinforced structure 110 increases the strength of the backplane 100 and reduces material usage of the backplane. As shown in FIG. 2 and FIG. 3, the surface of the backplane 100 is provided with a stiffener 200. The arrangement of the stiffener 200 is particularly suitable for producing a large-size backplane 100 without thickening the large-size backplane 100 and thus saves the materials. The stiffener 200 is locked on the backplane 100 by screw(s) 300, or is locked on the backplane 100 by other modes. In the embodiment, preferably, the stiffener 200 is locked by the method as shown in FIG. 4 to FIG. 6. As shown in FIG. 5, the stiffener 200 is locked on the backplane 100 by a fastener 120, and the fastener 120 is integrated with the backplane 100.

As shown in FIG. 6, a column structure 121 is formed on the backplane surface when the backplane 100 is modeled. After the stiffener 200 with hole(s) is assembled in the corresponding region arranged with the column structure 121, the column structure 121 is heated and softened by a heat source 130. Thereafter, the softened column structure 121 is cold punched and shaped by a cold punch 140 to form a fastener 120. The shape of the fastener 120 is similar to that of a screw, but is not limited to the shape as shown in the figure as long as a back-off structure pressing back on the stiffener 200 is formed on the column structure 121. In addition, the metal material or other material can be directly punched without heating. However, regardless of plastic material or metal material or other material, heating will result in a better plasticity and a small punching stress, so that the back-off structure becomes more stable. Thus, because the fastener 120 is formed on the backplane 100 and is integrated with the backplane 100, the fastener 120 can effectively lock the stiffener 200. For the stiffener with threaded connection, the backplane 100 made of plastic material is tapped to form threads. Because the strength and the rigidity of the backplane 100 made of plastic material are poor, the screw is easy to be loose because of threaded connection, and the stiffener 200 will be loose. Thus, the stiffening effect of the stiffener 200 is weakened. However, because the stiffener 200 locked by the fastener 120 formed on the backplane 100 is tightly connected with the backplane, the stiffener 200 will not be loose in absence of plastic deformation. Therefore, the stiffener 200 is tightly locked on the backplane 100, and then the stiffening function of the stiffener 200 is guaranteed. Thus, by the stiffening function of the reinforced structure 110 and the stiffener 200, the material usage of the backplane 100 is appropriately reduced, and then the manufacturing cost of the backplane 100 is saved.

In the region in which the stiffener 200 is arranged, the arranged reinforced structure 110 can be removed, and the thickness of the stiffener 200 is preferably equal to the height of the reinforced structure 110, so that the stiffener 200 can not protrude above the backplane 100 too much to affect the arrangement of other components. The structure strength of the backplane 100 is greatly increased by arranging the reinforced structure 110 and the stiffener 200, and the backplane is not thickened too much.

Because the material cost of the metal backplane is too high, the plastic material is preferably selected by the example of the present invention. Furthermore, the plasticity of the plastic material is good, the molding is convenient, and additional processing equipments are not required. Thus, the material cost and the processing cost are saved. However, the conception of the present invention is still applied to a metal backplane. The metal backplane is locked by arranging the stiffener and is locked by the fastener formed on the backplane, and the stiffening function of the stiffener is guaranteed. Under the condition, the thickness of the metal backplane can be appropriately reduced to achieve the purpose of saving material cost.

In addition, although the strength of the plastic material is lower than that of the metal material, the plasticity of the plastic material is better; the processing cost required by molding is lower than that of the metal material; and the price is lower. Therefore, the plastic material is preferable than the metal material under the condition that the strength meets the requirement. However, for an LCD device with high requirement for thickness, the backplane made of metal material is preferably selected because the backplane can be thinner than the backplane made of plastic material under the condition of high strength.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1 A backplane, comprising: a backplane surface and a stiffener fixed on the backplane surface; said stiffener being locked by a fastener which is integrated with said backplane surface and is formed on said backplane surface.

2. The backplane of claim 1, wherein said fastener is of a back-off structure formed by hot molding.

3. The backplane of claim 1, wherein said backplane is made of plastic material.

4. The backplane of claim 1, wherein said stiffener is made of metal material.

5. The backplane of claim 1, wherein said backplane surface is integrally formed with a reinforced structure which protrudes above the backplane surface.

6. The backplane of claim 5, wherein said reinforced structure is formed on the backplane surface and is formed as mutually-crossed strip-shaped structures.

7. The backplane of claim 5, wherein the arrangement of said reinforced structure excludes a region for fixing said stiffener.

8. The backplane of claim 7, wherein the thickness of said stiffener is equal to the height of said reinforced structure.

9. A back light module, comprising the backplane of claim 1; said backplane comprising a backplane surface and a stiffener fixed on the backplane surface; said stiffener being locked by a fastener which is integrated with said backplane surface and is formed on said backplane surface.

10. The back light module of claim 9, wherein said fastener is of a back-off structure formed by hot molding.

11. The back light module of claim 9, wherein said backplane is made of plastic material.

12. The back light module of claim 9, wherein said stiffener is made of metal material.

13. The back light module of claim 9, wherein said backplane surface is integrally formed with a reinforced structure which protrudes above the backplane surface.

14. The back light module of claim 13, wherein said reinforced structure is formed on the backplane surface and is formed as mutually-crossed strip-shaped structures.

15. The back light module of claim 13, wherein the arrangement of said reinforced structure excludes a region for fixing said stiffener.

16. The back light module of claim 15, wherein the thickness of said stiffener is equal to the height of said reinforced structure.

17. A method of locking a backplane stiffener comprising the following steps:
A: forming a column structure on a backplane surface of a backplane when molding the backplane;
B: correspondingly arranging a stiffener with hole(s) on the column structure on the backplane; and
C: punching and shaping the column structure to form a fastener that is used for locking said stiffener and is integrated with said backplane.
